(19) United States
(12) Patent Application Publication
(10) Pub. No.: US 2022/0311235 A1
(43) Pub. Date: Sep. 29, 2022

(54) CURRENT PULSE LIMITING PROTECTION

(71) Applicant: Snap-on Incorporated, Kenosha, WI (US)

(72) Inventors: Michael T. Rajzer, Kenosha, WI (US); Jason Genz, Kenosha, WI (US)

(73) Assignee: Snap-on Incorporated, Kenosha, WI (US)

(21) Appl. No.: 17/694,267

(22) Filed: Mar. 14, 2022

Related U.S. Application Data
(60) Provisional application No. 63/164,997, filed on Mar. 23, 2021.

(51) Int. Cl. H02H 7/08; H02H 1/00

(52) U.S. Cl. CPC H02H 7/0833; H02H 1/0007

(57) ABSTRACT

The present invention relates to current pulse limiting protection of a motorized device that includes a motor, a controller, and a power source (such as a battery). The controller implements current pulse limit protection to protect the controller and battery from damage due to overcurrent pulse events. For example, the controller may measure current flowing through the controller, and detect a number of current pulses that meets or crosses a first current threshold, regardless of a duration of each of the current pulses. The controller counts each current pulse that meets or crosses the first current threshold, and if the number of current pulses counted meets or exceeds a threshold number of pulses, the controller indicates a fault and ceases operation of the tool to protect the controller and battery from damage.

### CROSS REFERENCES TO RELATED APPLICATIONS

This application claims the benefit of U.S. Provisional Patent Application Ser. No. 63/164,997, filed Mar. 23, 2021, the contents of which are incorporated herein by reference in their entirety.

### TECHNICAL FIELD OF THE INVENTION

The present invention relates generally to electric motors, and more particularly to current pulse protection of components used to operate electric motors.

### BACKGROUND OF THE INVENTION

Power hand tools, such as, for example, motorized ratchet wrenches, impact wrenches, and other drivers, are commonly used in automotive, industrial, and household applications to install and remove threaded fasteners and apply a torque and/or angular displacement to a work piece, such as a threaded fastener, for example. Power hand tools generally include an output member (such as a drive lug or chuck), a trigger switch actuatable by a user, an electric motor contained in a housing, a motor controller, and other components, such as switches, light emitting diodes (LEDs), and a power source (e.g., batteries), for example.

Power typically flows from the power source, through the motor controller, to the motor, and the motor controller typically protects the controller and battery from damage due to an overcurrent event. When an overcurrent event occurs, the power tool will detect a fault and cease operation. However, some power tools can experience intermittent current pulses during normal operation. Due to the short duration of the current pulses, the power tool will not detect a fault and will continue to operate, which can damage the controller, battery, or user.

### SUMMARY OF THE INVENTION

The present invention relates broadly to current pulse limiting protection of a power tool. The tool includes a tool housing, an output assembly (such as a ratchet head assembly) adapted to provide torque to a work piece, a trigger, a motor housed in the housing, an indicator, a controller, and a power source. The controller implements current pulse limit protection to protect the controller and battery from damage due to overcurrent pulse events that occur during use of the tool. For example, the controller may measure the current flowing through the controller, and detect a number of current pulses (such as 7 pulses, for example) that meets or crosses a first current threshold (such as 45 A, for example), regardless of a duration of each of the current pulses. The controller counts each current pulse that meets or crosses the first current threshold based on a rising edge or falling edge of the current pulse, and once the current pulse meets or crosses a second current threshold (such as 60 A, for example), the controller looks for the next current pulse. If the number of current pulses counted meets or exceeds a threshold number of pulses (such as 7, for example), the controller indicates a fault and ceases operation of the tool to protect the controller and battery from damage.

The controller may also implement current limit protection to protect the controller and battery from damage due to an extended overcurrent event. For example, the controller may implement a current threshold limit (such as 100 A, for example), and a time threshold (such as 100 milliseconds, for example). The controller may measure the current flowing through the controller, and indicate a fault and cease operation of the tool when the current meets or exceeds the current threshold limit for a time that meets or exceeds the time threshold. By using the current pulse limit protection alone or in conjunction with current limit protection, damage to the battery and controller due to repeated overcurrent events is reduced.

### BRIEF DESCRIPTION OF THE DRAWINGS

For the purpose of facilitating an understanding of the subject matter sought to be protected, there is illustrated in the accompanying drawing embodiments thereof, from an inspection of which, when considered in connection with the following description, the subject matter sought to be protected, its construction and operation, and many of its advantages, should be readily understood and appreciated.

FIG. 1 is perspective view of an exemplar tool incorporating an embodiment of the present invention.

FIGS. 2 and 3 are block component diagrams of electronic components used with an exemplar tool, according to embodiments of the present invention.

FIG. 4 is a graphical illustration of an exemplary current waveform of current flowing through a controller of an exemplar tool without implementation of current pulse limit protection.

FIG. 5 is a graphical illustration of an exemplary current waveform of current flowing through a controller of the exemplar tool of FIG. 3, but with implementation of current pulse limit protection in accordance with an embodiment of the present invention.

FIG. 6 is a block diagram of a method of operation of current pulse limit protection, according to an embodiment of the present invention.

FIG. 7 is a block diagram of a method of operation of overcurrent protection, according to an embodiment of the present invention.

### DETAILED DESCRIPTION

While this invention is susceptible of embodiments in many different forms, there is shown in the drawings, and will herein be described in detail, a preferred embodiment of the invention with the understanding that the present disclosure is to be considered as an exemplification of the principles of the invention and is not intended to limit the broad aspect of the invention to embodiments illustrated. As used herein, the term “present invention” is not intended to limit the scope of the claimed invention and is instead a term used to discuss exemplary embodiments of the invention for explanatory purposes only.

The present invention relates broadly to current pulse limiting protection of an electrically operated motor, such as used with a power tool. The tool includes a tool housing, an output assembly (such as a ratchet head assembly) adapted to provide torque to a work piece, a trigger, a motor housed in the housing, an indicator, a controller, and a power source. The controller implements current pulse limit protection to protect the controller and battery from damage due to overcurrent pulse events. For example, the controller may measure the current flowing through the controller, and detect a number of current pulses (such as 7 pulses, for example) that meets or crosses a first current threshold (such as 45 A, for example), regardless of a duration of each of the current pulses. The controller counts each current pulse that meets or crosses the first current threshold based on a rising edge or falling edge of the current pulse, and once the current pulse meets or crosses a second current threshold (such as 60 A, for example), the controller looks for the next current pulse. If the number of current pulses counted by the controller meets or exceeds a threshold number (such as 7, for example), the controller indicates a fault and ceases operation of the tool to protect the controller and battery from damage.

The controller may also implement current limit protection to protect the controller and battery from damage due to an extended overcurrent event. For example, the controller may implement a current threshold limit (such as 100 A, for example), and a time threshold (such as 100 milliseconds, for example). The controller may measure the current flowing through the controller, and indicate a fault and cease operation of the tool when the current meets or exceeds the current threshold limit for a time that meets or exceeds the time threshold. By using the current pulse limit protection alone or in conjunction with current limit protection, damage to the battery and controller due to repeated overcurrent events is reduced.

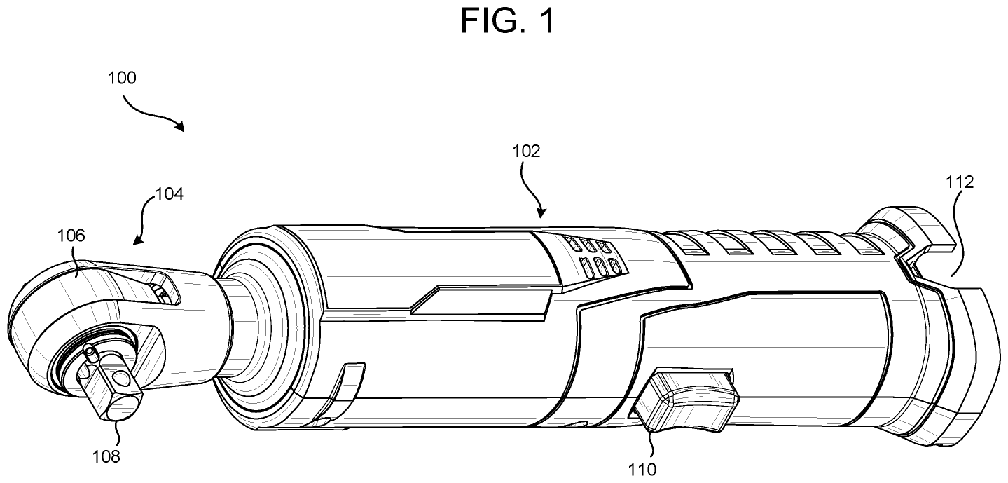

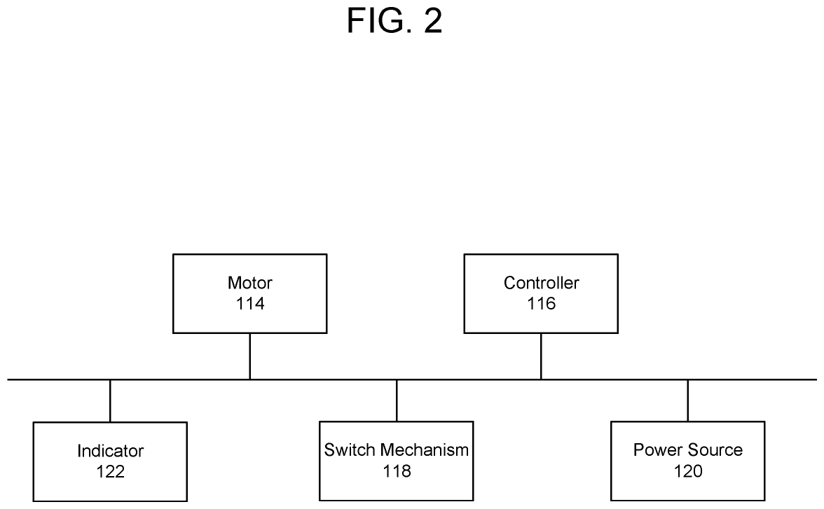

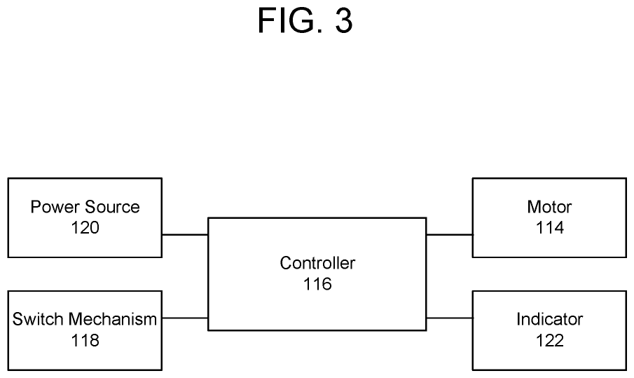

Referring to FIGS. 1-3, an exemplar tool 100 that can utilize the present invention, such as a cordless ratchet-type tool, includes a main tool housing 102 and output assembly 104 (such as a ratchet head assembly). The tool housing 102 may include first and second housing portions that are coupled together in a clamshell type manner and securely coupled to the output assembly 104. The tool housing 102 may enclose or house an electric motor 114 (shown in FIGS. 2 and 3), such as a brushless DC motor, controller 116 (shown in FIGS. 2 and 3), a switch assembly 118 (shown in FIGS. 2 and 3), display with buttons for configuring and setting the tool, one or more indicators 122 such as light emitting diodes, and other components for operation of the tool, for example. The tool housing 102 may also include a textured or knurled grip to improve a user's grasp of the tool 100 during use.

The output assembly 104 includes a drive portion 106 including a drive lug 108, for example. The drive lug 108 is adapted to apply torque to a work piece, such as a fastener, via an adapter, bit, or socket coupled to the drive lug 108, such as a bi-directional ratcheting square or hexagonal drive. As illustrated, the drive lug 108 is a “male” connector designed to fit into or matingly engage a female counterpart. However, the drive portion 106 may alternatively include a “female” connector designed to matingly engage a male counterpart. The drive portion 106 may also be structured to directly engage a work piece without requiring coupling to an adapter, bit, or socket. The rotational direction of the drive portion 106/drive lug 108 can be selected by rotation of a selector switch to be either a first or second rotational direction (such as, clockwise or counterclockwise).

The tool 100 also includes a trigger 110 that can be actuated by a user to cause the tool 100 to operate. For example, the user can depress the trigger 110 inwardly to selectively cause power to be drawn from a power source 120 and cause a motor 114 to provide torque to the output assembly 104 and cause the drive lug 108 to rotate in a desired rotational direction. The trigger 110 may also be operably coupled to a switch mechanism 118 that is adapted to cause power to be supplied from the power source 120 to the motor 114 when the trigger 110 is actuated. Any suitable trigger 110 or switch can be implemented without departing from the spirit and scope of the present invention. For example, the trigger 110 may also be biased such that the trigger 110 is inwardly depressible, relative to the tool 100, to cause the tool 100 to operate, and a release of the trigger 110 causes the trigger 110 to move outwardly, relative to the tool 100, to cease operation of the tool 100 via the biased nature of the trigger 110. The trigger 110 and switch mechanism 118 may also be a variable speed type mechanism. In this regard, actuation or depression of the trigger 110 causes the motor to operate at a faster speed the further the trigger 110 is depressed.

The motor 114 may be disposed in the tool housing 102 and be adapted to operably engage the output assembly 104, and provide torque to the tool 100 and, in turn, to the drive portion 106/drive lug 108. The motor 114 may be a brushless or brushed type motor, or any other suitable motor. A power source 120 can be associated with the tool 100 to provide electric power to the tool 100. In an embodiment, the power source 120 can be housed in an end 112 of the tool housing 102, opposite the output assembly 104, a midsection of the tool 100, or any other portion of the tool 100/tool housing 102. The power source 120 may also be an external component that is not housed by the tool 100, but that is operatively coupled to the tool 100 through, for example, wired or wireless means. In an embodiment, the power source 120 is a removable and rechargeable battery that is adapted to be disposed in the end of the tool housing 102 and electrically couple to corresponding terminals of the tool 100.

The controller 116 may be operably coupled to one or more of the power source 120, switch mechanism 118, indicator 122, and the motor 114. The controller 116 may include a central processing unit (CPU) for processing data and computer-readable instructions, and a memory for storing data and instructions. The memory may include volatile random access memory (RAM), non-volatile read only memory (ROM), and/or other types of memory. A data storage component may also be included, for storing data and controller/processor-executable instructions (for example, instructions for the operation and functioning of the tool 100). The data storage component may include one-or-more types of non-volatile solid-state storage, such as flash memory, read-only memory (ROM), magnetoresistive RAM (MRAM), ferroelectric RAM (FRAM), phase-change memory, etc.

Computer instructions for operating the tool 100 and its various components may be executed by the controller 116, using the memory as temporary “working” storage at runtime. The computer instructions may be stored in a non-transitory manner in non-volatile memory, storage, or an external device. Alternatively, some of the executable instructions may be embedded in hardware or firmware in addition to or instead of in software.

For example, the controller 116 may control the motor and implement of the current pulse limit protection and current limit protection methods described herein. When the trigger 110 is actuated, power flow from the power source 120, through the controller 116, and to the motor 114 to cause the output assembly 104 to operate. However, the tool 100 can experience intermittent current pulses during normal operation, which can cause damage to the controller 116, power source 120, and/or user.

The controller 116 may implement current pulse limit protection to protect the controller 116 and power source 120 from damage due to overcurrent pulse events. For example, the controller 116 may measure current flowing through the controller 116, and detect a number of current pulses that meets or crosses a first current threshold (such as 45 A, for example), regardless of a duration of each of the current pulses. The controller 116 counts each current pulse that meets or crosses the first current threshold based on a rising edge or falling edge of the current pulse, and once the current pulse meets or crosses a second current threshold (such as 60 A, for example), the controller 116 looks for the next current pulse. When the number of current pulses counted meets or exceeds a threshold number (such as 7, for example), the controller 116 indicates a fault (for example, by activating the indicator 122) and ceases operation of the tool 100 to protect the controller 116 and power source 120 from damage. The indicator 122 may be any type of indicator, such as a light emitting diode (LED), haptic actuator, display, etc. that is capable of indicating the fault to the user.

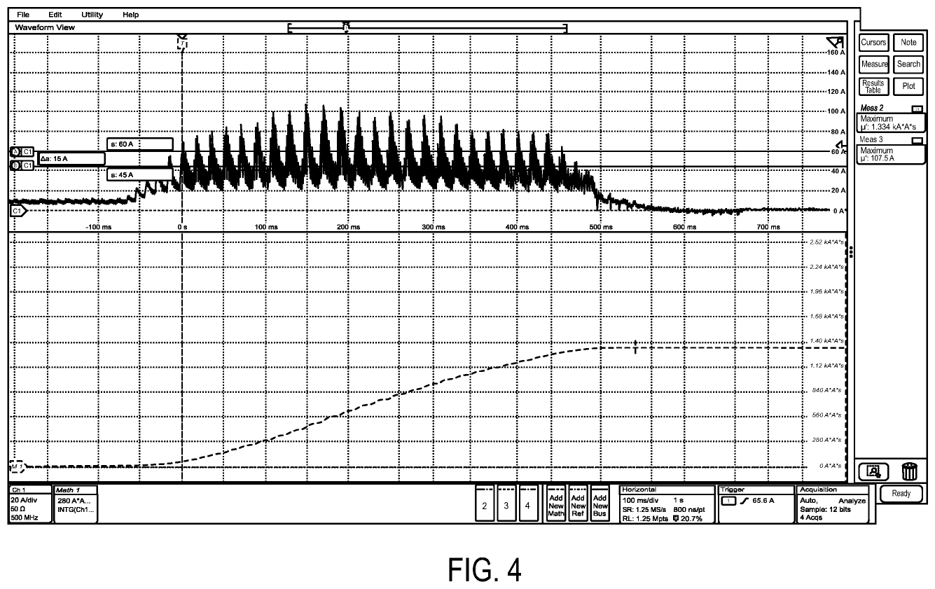

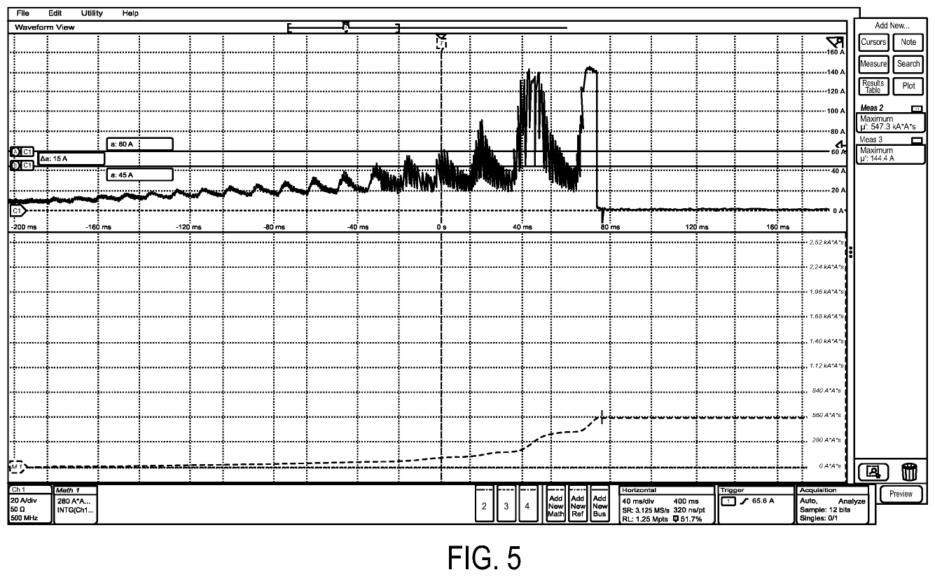

An exemplary current waveform of current flowing through the controller 116 without implementation of the current pulse limit protection is shown in FIG. 4. Similarly, an exemplary current waveform of current flowing through the controller 116 with the implementation of the current pulse limit protection is shown in FIG. 5. Based on a comparison of FIGS. 4 and 5, without implementation of the current pulse limit protection of the present invention, the controller 116 may typically experience numerous current pulses from time 0 ms to about time 500 ms that can damage the controller 116 and/or power source 120. However, when an embodiment of the present invention is implemented, as shown in FIG. 5, the present invention causes the controller 116 to indicate a fault (for example, by activating the indicator 122) and cease operation of the tool 100 at about time 60-80 ms to protect the controller 116 and power source 120 from damage.

The controller 116 may also implement another current limit protection to protect the controller 116 and power source 120 from damage due to an extended overcurrent event. For example, the controller 116 may implement a current threshold limit (such as 100 A, for example) and a time threshold (such as 100 milliseconds, for example). The controller 116 may measure the current flowing through the controller 116, and indicate a fault (for example, by activating the indicator 122) and cease operation of the tool when the current meets or exceeds the current threshold limit for a period of time that meets or exceeds the time threshold. By using the current pulse limit protection alone or in conjunction with current limit protection, the risk of damage to the power source 120 and controller 116 due to overcurrent events is reduced.

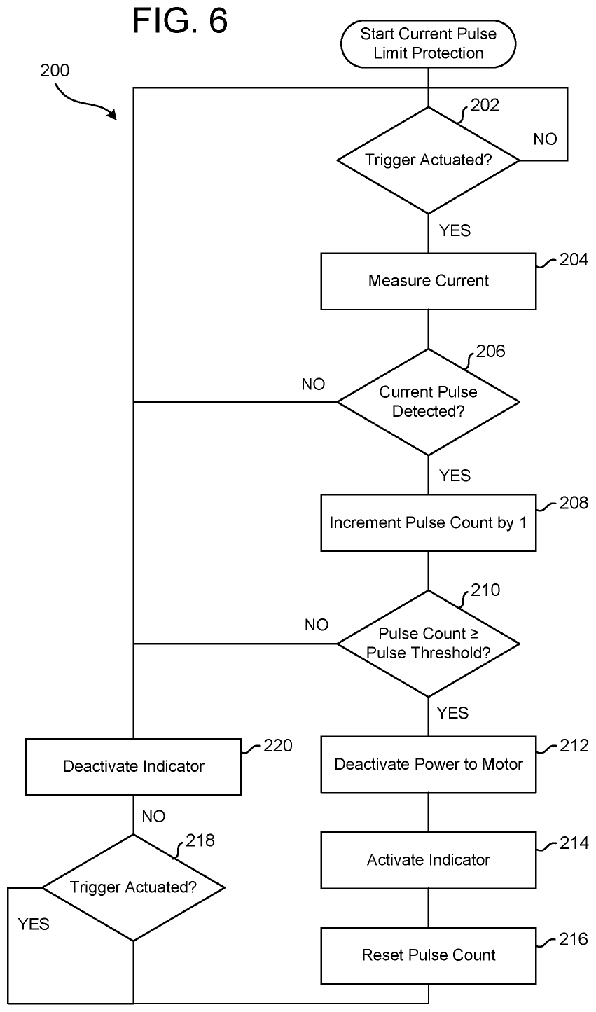

Referring to FIG. 6, a current pulse limit protection method 200 of operation of an exemplar tool 100 using an embodiment of the present invention is described. The method begins when the trigger is actuated or the tool 100 is otherwise activated to supply power to the motor 114, illustrated as block 202. The tool (such as via controller 116) measures the current flowing through the controller 116 to the motor 114, illustrated as block 204. The tool (such as via controller 116) determines whether a current pulse is detected based on measuring the current, illustrated as block 206. For example, a current pulse may be detected when the current meets, crosses, or exceeds a first current threshold (such as 45 A, for example), and then meets, crosses, or drops below a second current threshold (such as 60 A, for example), regardless of a duration of each of the current pulses. When a current pulse is detected, the tool (such as via controller 116) may increment a pulse counter by 1, illustrated as block 208. When the current meets, crosses, or drops below the second current threshold, the controller 116 looks for the next current pulse. However, when a current pulse is not detected, the tool (such as via controller 116) may proceed back to block 202 and continue to measure the current.

After detecting one or more current pulses, the tool (such as via controller 116) may determine whether the pulse count is greater than or equal to a pulse threshold number (such as 7, for example), illustrated as block 210. When the pulse count is less than the pulse threshold number, the tool (such as via controller 116) may proceed back to block 202 and continue to measure the current. When the pulse count is greater than or equal to the pulse threshold number, the tool (such as via controller 116) may cease or deactivate power to the motor, illustrated as block 212, to reduce a risk of damage to the controller 116 and/or power source 120. The tool (such as via controller 116) may also activate the indicator to indicate a fault to the user, illustrated as block 214. The indicator may continue to be activated for a period of time (such as 5 to 10 seconds), thereafter, the tool (such as via controller 116) may cause the indicator to be deactivated to conserve power. The tool (such as via controller 116) may also reset the pulse count, illustrated as block 216

The tool (such as via controller 116) may proceed to block 218, and determine whether the tool has been reactivated by determining whether the trigger has been actuated. When the trigger is not actuated, the tool (such as via controller 116) may cause the indicator to be deactivated to conserve power, illustrated as block 220. However, when the trigger continues to be actuated, the tool (such as via controller 116) may continue to cause the indicator to be activated to indicate the fault.

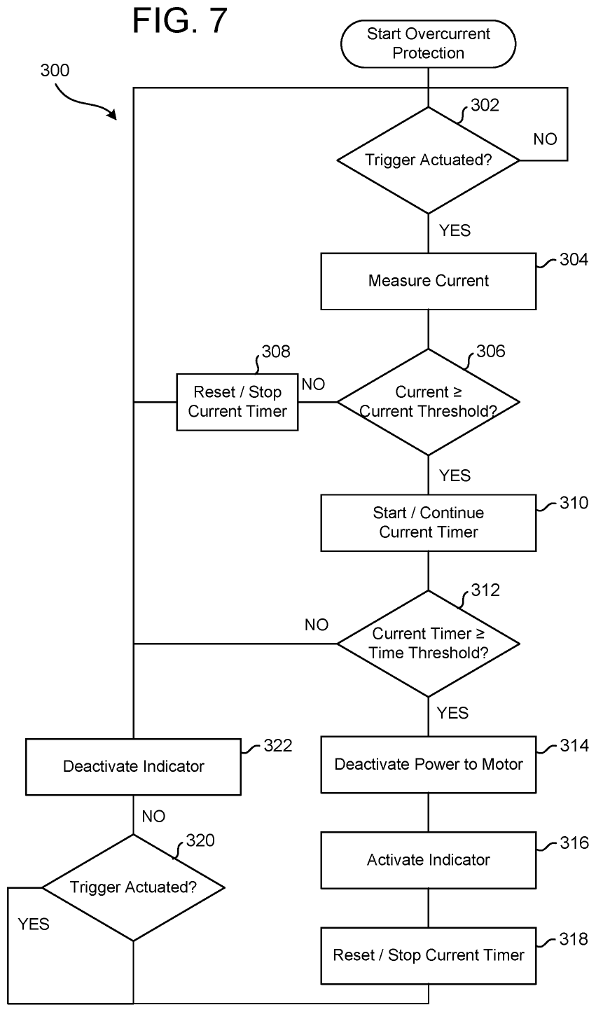

The method 200 may be performed alone or in conjunction with another current limit protection method. For example, referring to FIG. 7, an overcurrent protection method 300 of operation of an exemplar tool 100 using an embodiment of the present invention is described. The method begins when the trigger is actuated or the tool 100 is otherwise activated to supply power to the motor 114, illustrated as block 302. The tool (such as via controller 116) measures the current flowing through the controller 116 to the motor 114, illustrated as block 304. The tool (such as via controller 116) determines whether the current is greater than or equal to a current threshold (such as 100 A, for example), illustrated as block 306. When the current is less than the current threshold, the tool (such as via controller 116) may reset and/or stop a current timer, illustrated as block 308, and proceed back to block 302 and continue to measure the current. However, when the current is greater than or equal to the current threshold, the tool (such as via controller 116) may initiate the current timer to measure how long the current is greater than or equal to the current threshold, illustrated as block 310.

After initiating the timer, the tool (such as via controller 116) may determine whether the timer value is greater than or equal to a time threshold (such as 100 milliseconds, for example), illustrated as block 312. When the timer value of how long the measured current was greater than or equal to the current threshold is less than the time threshold, the tool (such as via controller 116) may proceed back to block 302 and continue to measure the current. However, when the timer value of how long the measured current was greater than or equal to the current threshold is greater than or equal to the time threshold, the tool (such as via controller 116) may cease or deactivate power to the motor, illustrated as block 314, to reduce a risk of damage to the controller 116 and/or power source 120. The tool (such as via controller 116) may also activate the indicator to indicate a fault to the user, illustrated as block 316. The indicator may continue to be activated for a period of time (such as 5 to 10 seconds), thereafter, the tool (such as via controller 116) may cause the indicator to be deactivated to conserve power. The tool (such as via controller 116) may also reset and/or stop the current timer, illustrated as block 318

The tool (such as via controller 116) may proceed to block 320, and determine whether the tool has been reactivated by determining whether the trigger has been actuated. When the trigger is not actuated, the tool (such as via controller 116) may cause the indicator to be deactivated to conserve power, illustrated as block 322. However, when the trigger continues to be actuated, the tool (such as via controller 116) may continue to cause the indicator to be activated to indicate the fault.

By using the current pulse limit protection of the present invention alone or in conjunction with current limit protection, the risk of damage to the power source 120 and controller 116 due to overcurrent events is reduced.

As discussed herein, the exemplar tool 100 that incorporates an embodiment of the present invention is a ratchet-type wrench. However, it will be appreciated that the present invention can be used with any type of hand-held motorized tool, including, without limitation, electrically powered or motorized tools, such as a drill, router, or impact wrench, ratchet wrench, screwdriver, or other powered tool, that is powered by electricity via an external power source (such as a wall outlet and/or generator outlet) or a battery. Also, while the present invention is described as being used with a tool, which is exemplar, the present invention can be used with or incorporated into any electrically operated motor devices.

As used herein, the term “coupled” and its functional equivalents are not intended to necessarily be limited to direct, mechanical coupling of two or more components. Instead, the term “coupled” and its functional equivalents are intended to mean any direct or indirect mechanical, electrical, or chemical connection between two or more objects, features, work pieces, and/or environmental matter. “Coupled” is also intended to mean, in some examples, one object being integral with another object. As used herein, the term “a” or “one” may include one or more items unless specifically stated otherwise.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of the inventors' contribution. The actual scope of the protection sought is intended to be defined in the following claims when viewed in their proper perspective based on the prior art.

What is claimed is:

1. A method of operating a controller and a motor operably coupled to a power source, wherein the power source is adapted to supply power to the motor, the method comprising:
measuring current flowing from the power source through the controller to the motor;
counting a number of current pulses in the current flowing from the power source through the controller to the motor; and
causing the power source to stop supplying power to the motor when the number of current pulses meets or exceeds a pulse threshold.

2. The method of claim 1, further comprising detecting the current pulses, wherein each of the current pulses is detected when the current meets or crosses a first current threshold and then meets or crosses a second current threshold.

3. The method of claim 1, wherein counting the number of current pulses includes incrementing a pulse counter.

4. The method of claim 1, further comprising activating an indicator when the number of current pulses meets or exceeds the pulse threshold.

5. The method of claim 4, further comprising deactivating the indicator after a predetermined amount of time.

6. The method of claim 4, further comprising:
determining whether a trigger is actuated; and
continuing to activate the indicator until the trigger is not actuated.

7. The method of claim 1, further comprising resetting the number of current pulses after causing the power source to stop supplying power to the motor.

8. The method of claim 1, further comprising:
determining whether the current meets or exceeds a current threshold; and
initiating a current timer to measure a time value corresponding to an amount of time that the current meets or exceeds the current threshold.

9. The method of claim 8, further comprising causing the power source to stop supplying power to the motor when the time value meets or exceeds a time threshold.

10. The method of claim 9, further comprising activating an indicator when the time value meets or exceeds the time threshold.

11. A tool including a motor and a power source adapted to supply power to the motor, comprising:
a controller adapted to:
measure current flowing from the power source through the controller to the motor;
count a number of current pulses; and
cause the power source to stop supplying power to the motor when the number of current pulses meets or exceeds a pulse threshold.

12. The tool of claim 11, wherein the controller is further adapted to detect the current pulses, wherein each of the current pulses is detected when the current meets or crosses a first current threshold and then meets or crosses a second current threshold.

13. The tool of claim 11, further comprising a pulse counter, wherein the controller is further adapted to count the number of current pulses by incrementing the pulse counter.

14. The tool of claim 11, further comprising an indicator, wherein the controller is further adapted to activate the indicator when the number of current pulses meets or exceeds the pulse threshold.

15. The tool of claim 14, wherein the controller is further adapted to deactivate the indicator after a predetermined amount of time.

16. The tool of claim 14, further comprising a trigger that, when actuated, causes the power source to supply the power to the motor, and wherein the controller is further adapted to:
determine the trigger is actuated; and
continue to activate the indicator until the trigger is not actuated.

17. The tool of claim 11, wherein the controller is further adapted to reset the number of current pulses after causing the power source to stop supplying power to the motor.

18. The tool of claim 11, wherein the controller is further adapted to:
determine the current meets or exceeds a current threshold; and
initiate a current timer to measure a time value corresponding to an amount of time that the current meets or exceeds the current threshold.

19. The tool of claim 18, wherein the controller is further adapted to cause the power source to stop supplying power to the motor when the time value meets or exceeds a time threshold.

20. The tool of claim 19, further comprising an indicator, wherein the controller is further adapted to activate the indicator when the time value meets or exceeds the time threshold.
